(19) United States
(12) Patent Application Publication
(10) Pub. No.: US 2012/0275980 A1
(43) Pub. Date: Nov. 1, 2012

(54) MEANS AND METHODS FOR UTILIZING SODIUM HYDROXIDE

(75) Inventors: Riki Canari, M.P. Harei Yehuda (IL); Johan Ivar Ervik, Trondhejm (NO)

(73) Assignee: CLEAN MARINE AS, Oslo (NO)

(21) Appl. No.: 13/516,735

(22) PCT Filed: Dec. 16, 2010
(86) PCT No.: PCT/IL10/01069

§ 371 Date: Jun. 17, 2012

(30) Foreign Application Priority Data
Dec. 17, 2009 (IL) 202817

(51) Int. Cl. B01D 53/50

(52) U.S. Cl. 423/243.08

(57) ABSTRACT

A method and apparatus for diluting a solution of an alkali metal hydroxide (MOH) by using seawater or any other aqueous solution are disclosed, in which a concentrated MOH solution and seawater contact opposite sides of a membrane adapted to transmit water but not other molecules, thus creating a diluted solution of MOH and concentrated brine. Additional embodiments include means for limiting fouling of the system by removing Ca and Mg from the seawater by precipitation or reaction with a flocculant. Means and methods for adapting the method and apparatus for use in a flue gas desulfurization system are also disclosed.

### REFERENCE TO RELATED APPLICATION

This application claims priority from Israel Patent Application No. 202817, Filed 17 Dec. 2009.

### FIELD OF THE INVENTION

The present invention relates to a process for diluting a concentrated solution of sodium hydroxide. In particular, it relates to a process for creating a dilute solution of sodium hydroxide for use in a flue gas desulfurization (FGD) system.

### BACKGROUND OF THE INVENTION

Ships are fast becoming the largest source of air pollution in the EU. Unless more action is taken, by 2020, they will be a more significant source of gas and particulate pollution than all land sources combined.

As a result, the International Maritime Organization (IMO) has strengthened its requirements for reduction of emissions of sulphur oxides (SOₓ) and particulate matter (PM) (59th session of the Marine Environment Protection Committee, 16 Jul. 2009).

While one method for reducing SOₓ emissions is the use of low-sulphur fuels, EU legislation allows as an alternative the use of technologies that abate the sulphur content in the emitted gas.

Wet scrubbers using sodium hydroxide solution are widely used in flue gas desulfurization (FGD). Since equipment size is particularly critical on board ships, where the available space is limited, a very concentrated base solution (typically 50% NaOH) is stored on board and used in FGD only after dilution. Diluting the basic solution with sea water is problematic, since the high pH leads to precipitation of insoluble calcium and magnesium salts, fouling the system. Thus, in most cases expensive fresh water must be used rather than readily available and costless sea water.

U.S. Pat. No. 7,198,722 to Hussain, incorporated herein by reference, discloses process for treating seawater involving precipitation of calcium and/or magnesium from the water, separating the precipitate, desalinating the seawater, and dividing the water into two streams, one of which has a higher concentration of dissolved solids than the other.

Gibbs et al., TAPPI J. 1997, 80, 163, “Flocculants for precipitated calcium carbonate in newsprint pulps,” which is incorporated herein by reference, investigated the retention of precipitated calcium carbonate (PCC) in newsprint pulp (15 wt. % semibleached kraft+85 wt. % peroxide-bleached mechanical) using polymeric flocculants. Their results provide some guidance to the types of commercial retention aids that may be effective for PCC retention, as Ca⁺⁺ ion sensitivity, displayed by some retention aids, is an important issue.

A cost effective method for diluting a highly concentrated sodium hydroxide solution for use in FGD that does not lead to problematic precipitation in the scrubbing system remains a long-felt need.

### SUMMARY OF THE INVENTION

The main objective of the present invention is to provide a cost effective method for diluting concentrated sodium hydroxide solutions using sea water and without forming problematic precipitates in the scrubbing system.

It is thus one object of the present invention to disclose a method for diluting a solution of an alkali metal hydroxide (MOH) by using a second aqueous solution, said process comprising the steps of (a) providing a concentrated solution of at least one alkali metal hydroxide; (b) providing a second aqueous solution; (c) providing a membrane that selectively transmits water molecules; (d) contacting said alkali hydroxide solution with said membrane; and (e) contacting said second aqueous solution with the other side of said membrane such that water molecules are transmitted from said second aqueous solution through said membrane to said alkali metal hydroxide solution. It is within the essence of the invention whereby a dilute alkali metal hydroxide solution and a concentrated aqueous solution are formed.

It is a further object of this invention to disclose such a method, wherein said alkali metal hydroxide is sodium hydroxide.

It is a further object of this invention to disclose such a method, wherein said second aqueous solution is selected from the group consisting of brackish water, processed water, wastewater, aqueous industrial streams, seawater, at least partially treated salt water, or any combination thereof.

It is a further object of this invention to disclose such a method, wherein said second aqueous solution is seawater.

It is a further object of this invention to disclose such a method, wherein the concentration of said alkali metal hydroxide solution is between about 10% MOH and about 50% MOH.

It is a further object of this invention to disclose such a method, wherein the concentration of said alkali metal hydroxide solution is between about 30% MOH and about 50% MOH.

It is a further object of this invention to disclose such a method, wherein the volume ratio between said alkali metal hydroxide solution and said second aqueous solution is between about 1:6000 and about 1:400.

It is a further object of this invention to disclose such a method, wherein said membrane is selected from the group consisting of ceramic membranes, polypropylene membranes, polysulfonate membranes, and any combination thereof.

It is a further object of this invention to disclose such a method, further comprising an additional step of introducing at least part of at least one of said solutions into a flue gas desulfurization (FGD) system, whereby a treated flue gas stream and a used solution stream are formed.

It is a further object of this invention to disclose such a method, further comprising an additional step of operating said FGD system on a ship.

It is a further object of this invention to disclose such a method, further comprising an additional step of operating said FGD system as a closed-loop operation, whereby less than 10% of said used solution stream is discharged.

It is a further object of this invention to disclose such a method, further comprising an additional step of operating said FGD system as a once-through operation, whereby the majority of said used solution stream is discharged.

It is a further object of this invention to disclose such a method, wherein said FGD system includes a pre-injection zone and a scrubbing unit.

It is a further object of this invention to disclose such a method, wherein said scrubbing unit includes at least one cyclone unit.

It is a further object of this invention to disclose such a method, further comprising an additional step of introducing at least part of said diluted stream of alkali metal hydroxide solution into said FGD system through at least one inlet in at least one of (a) said pre-injection zone and (b) in said scrubbing unit.

It is a further object of this invention to disclose such a method, further comprising an additional step of introducing at least part of said concentrated aqueous solution into said FGD system through at least one inlet in said scrubbing unit.

It is a further object of this invention to disclose such a method, further comprising an additional step of providing osmotic pressure, wherein said osmotic pressure eliminates the need for a separate injection pump.

It is a further object of this invention to disclose a method for diluting a alkali metal hydroxide solution, comprising the steps of (a) providing a concentrated alkali metal hydroxide solution; (b) providing a second aqueous solution; (c) providing a membrane that selectively transmits water molecules; (d) providing an FGD system, wherein said FGD system comprises a pre-injection zone and a cyclone unit; (e) contacting said alkali metal hydroxide solution with one side of said membrane; (f) contacting said second aqueous solution with the other side of said membrane such that water molecules are transmitted from said second aqueous solution through said membrane to said alkali metal hydroxide solution, whereby the concentration of said alkali metal hydroxide solution decreases and the concentration of said second aqueous solution increases during at least part of the time that said two solutions are in contact with said membrane and further whereby a diluted alkali metal hydroxide stream and a concentrated second aqueous solution stream are formed; (g) injecting at least a part of said diluted alkali metal hydroxide stream into injection points in said pre-injection zone of said FGD system; and (h) injecting at least a part of said concentrated second aqueous solution stream into said cyclone unit. It is within the essence of the invention wherein the diluent for said alkali metal hydroxide solution comprises water derived from said second aqueous solution.

It is a further object of this invention to disclose a method for treating flue gas within a flue gas desulfurization (FGD) system said process comprising steps of (a) providing a FGD system comprising a seawater pretreatment (SWPT) module; (b) mixing seawater with a basic solution within said SWPT module, whereby a precipitate comprising calcium and/or magnesium compounds is formed; (c) dividing said mixture into at least two streams, at least one of which is a precipitate-rich stream and at least one of which is a precipitate-lean stream; and (d) introducing at least part of said precipitate-rich and precipitate-lean streams into said flue gas desulfurization (FGD) system for treating flue gas.

It is a further object of this invention to disclose such a method, wherein said basic solution contains at least one solute from the group consisting of (a) sodium hydroxide and (b) sodium bicarbonate.

It is a further object of this invention to disclose such a method, wherein said step of mixing seawater with a basic solution further comprises the additional step of mixing seawater with a solution of alkali metal hydroxide, wherein the concentration of said alkali metal hydroxide solution is between about 10% MOH and about 50% MOH.

It is a further object of this invention to disclose such a method, wherein said step of mixing seawater with a basic solution further comprises the additional step of mixing seawater with a solution of alkali metal hydroxide, wherein the concentration of said alkali metal hydroxide solution is between about 30% MOH and about 50% MOH.

It is a further object of this invention to disclose such a method, wherein the volume ratio between said basic solution and said second aqueous solution is between about 1:4000 and about 1:50.

It is a further object of this invention to disclose such a method, wherein the volume ratio between said basic solution and said second aqueous solution is between about 1:1000 and about 1:50.

It is a further object of this invention to disclose such a method, wherein the volume ratio between said basic solution and said seawater is between about 1:500 and about 1:100.

It is a further object of this invention to disclose such a method, further comprising an additional step of filtering or ultra-filtering.

It is a further object of this invention to disclose such a method, further comprising an additional step of adding an effective measure of at least one flocculant and/or agglomerate to at least one stream selected from the group consisting of said mixture, said precipitate-rich stream, and said precipitate-lean stream.

It is a further object of this invention to disclose such a method, wherein said at least one flocculant comprises a hydrocolloid-based flocculant.

It is a further object of this invention to disclose such a method, wherein said at least one flocculant poses little or no risk to the marine environment as defined by the relevant OSPAR standard.

It is a further object of this invention to disclose such a method, further comprising an additional step of adding at least one compound selected from the group consisting of CO₂ and NaHCO₃ to at least one stream selected from the group consisting of said mixture, said precipitate-rich stream, and said precipitate-lean stream.

It is a further object of this invention to disclose such a method, wherein said step adding at least one compound selected from the group consisting of CO₂ and NaHCO₃ to at least one stream selected from the group consisting of said mixture, said precipitate-rich stream, and said precipitate-lean stream further comprises the additional step of adding CO₂ obtained from said flue gas after said treatment to at least one stream selected from the group consisting of said mixture, said precipitate-rich stream, and said precipitate-lean stream.

It is a further object of this invention to disclose such a method, further comprising an additional step of adding a solid comprising a compound selected from the group consisting of CaCO₃, Ca(OH)₂, and any combination thereof to at least one stream selected from the group consisting of said mixture, said precipitate-rich stream, and said precipitate-lean stream.

It is a further object of this invention to disclose such a method, wherein said FGD system further comprises a pre-injection zone.

It is a further object of this invention to disclose such a method, further comprising an additional step of introducing at least part of said precipitate-lean stream into said pre-injection zone.

It is a further object of this invention to disclose such a method, further comprising an additional step of operating said FGD system on a ship.

It is a further object of this invention to disclose a method for treating flue gas within a flue gas desulfurization (FGD) system, said process comprising steps of (a) providing an FGD system adapted for treating flue gas with an aqueous solution whereby treated flue gas and used water are formed, said FGD system comprising a seawater pretreatment module; (b) mixing said aqueous solution with a substance that selectively bonds divalent ions over monovalent ions (SSBD), said substance selected from the group containing (1) flocculants, (2) complexants, and (3) ion exchange materials, whereby a SSBD which is bonded to the divalent ion is formed inside treated seawater; (c) separating said bonded SSBD from said treated aqueous solution; (d) mixing at least part of said treated aqueous solution stream with an MOH solution; and (e) introducing at least part of said mixture into said flue gas desulfurization (FGD) system for treating flue gas.

It is a further object of this invention to disclose such a method, wherein said aqueous solution is seawater.

It is a further object of this invention to disclose such a method, further comprising an additional step of operating said FGD system on a ship.

It is a further object of this invention to disclose such a method, wherein said at least one flocculant comprises a hydrocolloid-based flocculant.

It is a further object of this invention to disclose such a method, wherein said FGD system includes at least one cyclone unit.

It is a further object of this invention to disclose such a method, further comprising an additional step where said bonded SSBD is added to said used water.

It is a further object of this invention to disclose a device for diluting a concentrated solution of MOH, comprising (a) a storage tank adapted for storing concentrated MOH solution; (b) a source of a second aqueous solution; (c) a membrane unit comprising: (i) a chamber; (ii) at least one hydroxide solution inlet fluidly connected to said storage tank and adapted to admit a fluid, mixture of fluids, and/or solution into said chamber; (iii) at least one aqueous solution inlet fluidly connected to said source of a second aqueous solution and adapted to admit a fluid, mixture of fluids, and/or solution into said chamber; (iv) at least one hydroxide solution outlet; (v) at least one aqueous solution outlet; and (vi) an interior wall disposed within said chamber so as to divide said chamber into (1) at least one hydroxide flow chamber, said at least one hydroxide flow chamber fluidly connected to at least one hydroxide solution inlet and further fluidly connected to at least one hydroxide solution outlet and (2) at least one aqueous solution flow chamber, said at least one aqueous solution flow chamber fluidly connected to at least one aqueous solution inlet and further fluidly connected to at least one aqueous solution outlet, said wall at least partially comprising a membrane that is adapted to transmit selectively water molecules from one side of said membrane to the other, said membrane disposed such that one side of said membrane is in fluid contact with said at least one hydroxide flow chamber and the other side of said membrane is in fluid contact with said aqueous solution flow chamber. It is within the essence of the invention wherein said device is adapted to dilute a concentrated solution of MOH with water transmitted across said membrane from a second aqueous solution.

It is a further object of this invention to disclose such a device for diluting a concentrated solution of MOH, wherein said means for fluidly connecting at least one of (a) said alkali hydroxide outlet or (b) said aqueous solution outlet to said at least one liquid inlet comprises means for fluidly connecting said alkali hydroxide outlet to said liquid inlet.

It is a further object of this invention to disclose such a device for diluting a concentrated solution of MOH, wherein said source of a second aqueous solution comprises a source of seawater and an intake adapted to deliver seawater to said fluid connection source of a second aqueous solution and said aqueous solution inlet.

It is a further object of this invention to disclose such a device for diluting a concentrated solution of MOH, wherein said membrane is chosen from the group consisting of consisting of ceramic membranes, polypropylene membranes, polysulfonate membranes, and any combination thereof.

It is a further object of this invention to disclose such a device for diluting a concentrated solution of MOH, wherein said device is located on a ship.

It is a further object of this invention to disclose a device for desulfurization of flue gas, comprising (a) at least one scrubbing unit for treating flue gas, said at least one scrubbing unit comprising (i) at least one liquid inlet adapted to admit at least one solution into said scrubbing unit; (ii) at least one liquid outlet adapted to provide exit means for said at least one solution from said scrubbing unit; (iii) at least one inlet for flue gas connectable to a source of flue gas; and (iv) at least one outlet for said flue gas, said at least one scrubbing unit adapted to allow fluid contact between said at least one solution and said flue gas; and (b) a storage tank adapted for storage of a concentrated solution of an alkali metal hydroxide fluidly connected to said at least one liquid inlet. It is within the essence of the invention wherein said device further comprises (c) a source of a second aqueous solution; (d) a membrane unit comprising (i) a chamber; (ii) at least one hydroxide solution inlet fluidly connected to said storage tank and adapted to admit a fluid, mixture of fluids, and/or solution into said chamber; (iii) at least one aqueous solution inlet fluidly connected to said source of a second aqueous solution and adapted to admit a fluid, mixture of fluids, and/or solution into said chamber; (iv) at least one hydroxide solution outlet; (v) at least one aqueous solution outlet; and (vi) an interior wall disposed within said chamber so as to divide said chamber into (1) at least one hydroxide flow chamber, said at least one hydroxide flow chamber fluidly connected to at least one hydroxide solution inlet and further fluidly connected to at least one hydroxide solution outlet and (2) at least one aqueous solution flow chamber, said at least one aqueous solution flow chamber fluidly connected to at least one aqueous solution inlet and further fluidly connected to at least one aqueous solution outlet, said wall at least partially comprising a membrane that is adapted to transmit selectively water molecules from one side of said membrane to the other, said membrane disposed such that one side of said membrane is in fluid contact with said at least one hydroxide flow chamber and the other side of said membrane is in fluid contact with said aqueous solution flow chamber; (e) a fluid connection between at least one of (a) said alkali hydroxide outlet or (b) said aqueous solution outlet and said at least one liquid inlet; (f) means for controllably transferring a concentrated solution of alkali metal hydroxide from said storage tank to said at least one alkali hydroxide solution outlet via said at least one alkali hydroxide solution inlet and said at least one alkali hydroxide solution flow chamber; and (g) means for controllably transferring a second aqueous solution from said source of said second aqueous solution to said aqueous solution outlet via said at least one aqueous solution inlet and said at least one aqueous solution flow chamber.

It is a further object of this invention to disclose such a device, wherein said means for fluidly connecting at least one of (a) said alkali hydroxide outlet or (b) said aqueous solution outlet to said at least one liquid inlet comprises means for fluidly connecting said alkali hydroxide outlet to said liquid inlet.

It is a further object of this invention to disclose such a device, wherein said source of a second aqueous solution comprises a source of seawater and an intake adapted to deliver seawater to said fluid connection source of a second aqueous solution and said aqueous solution inlet.

It is a further object of this invention to disclose such a device, wherein said membrane is chosen from the group consisting of consisting of ceramic membranes, polypropylene membranes, polysulfonate membranes, and any combination thereof.

It is a further object of this invention to disclose such a device, wherein said device is located on a ship.

### BRIEF DESCRIPTION OF THE DRAWINGS

Non-limiting and non-exhaustive embodiments of the present invention are described with reference to the following drawings. In the drawings, like reference numbers refer to like parts throughout the various figures unless otherwise specified.

For a better understanding of the present invention, and to illustrate how it may be implemented in practice, a plurality of embodiments will now be described, by way of non-limiting example only, with reference to the accompanying drawings, wherein:

FIG. 1 presents a schematic diagram of a means and method for using seawater to dilute a solution of MOH according to one embodiment of the present invention;

FIG. 2 illustrates schematically “once through” operation according to one embodiment of the present invention; and

FIG. 3 illustrates schematically “closed loop” operation according to one embodiment of the present invention.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of said claims.

As used herein, the abbreviation MOH refers to a generic alkali metal hydroxide (M=one of Li, Na, K, Rb, Cs, and Fr).

As used herein, the term ship refers to any vessel that is adapted to travel on or under the surface of a body of water.

As used herein, the term on a ship refers to any location that travels with the ship; that is, while an object “on a ship” may be located on the uppermost deck of a ship, it need not necessarily be so. As non-limiting examples, an object located within the hull of the ship, attached to the hull of the ship, tethered to at least part of the ship but otherwise on or in the body of water upon which the ship is traveling, etc., would be considered to be “on a ship” according to the definition of the term as used herein.

As used herein, the term preinjection zone refers to a zone within a wet flue-gas desulfurization system within which the SO₂-laden gas undergoes preliminary desulfurization by contacting a relatively small amount of scrubbing solution.

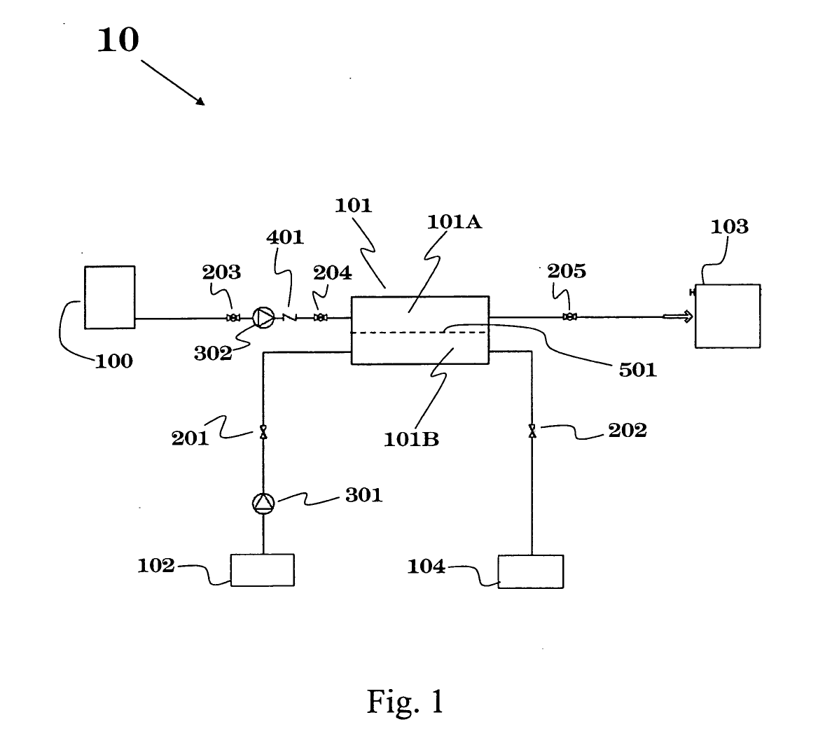

Reference is now made to FIG. 1, which illustrates schematically a method 10 of using seawater to dilute a solution of MOH according to one embodiment of the present invention. A solution of MOH is stored in tank 100. In preferred embodiment of the invention, the concentration of the solution is between about 10% and about 50% MOH (w/v). In a more preferred embodiment of the invention, the concentration of the MOH solution is between about 30% and about 50% (w/v). In most preferred embodiments of the invention, the alkali metal hydroxide used is NaOH.

The method and system herein disclosed further comprises membrane unit 101, which comprises at least one membrane 501. Membrane 501 is of a type that selectively transmits water molecules, but not more than a negligible amount of solute. Such membranes are well-known in the art; examples of suitable materials for the membrane include ceramic, polypropylene, and polysulfonates. Membrane unit 101 is divided into at least two chambers (in the embodiment illustrated in FIG. 1, it is divided into two chambers 101A and 101B), with membrane 501 disposed within the membrane unit such that fluid within chamber 101A can contact one side of the membrane and fluid within chamber 101B can contact the other side of the membrane. Membrane unit 101 is constructed such that the chambers are substantially isolated from one another, i.e., passage of molecules from one chamber to the other can occur substantially only via membrane 501.

The MOH solution flows from tank 100 to membrane unit 101; in the embodiment illustrated in FIG. 1, the MOH solution is introduced into chamber 101A. In preferred embodiments of the invention, the MOH solution flows from tank 100 to the membrane unit via valve 203, pump 302, check valve 401, and a second valve 204.

Seawater is introduced into membrane unit 101 (in the embodiment illustrated in FIG. 1, into chamber 101B) via seawater intake 102. In preferred embodiments of the invention, the seawater passes through pump 301 and valve 201. Except for contact with the two sides of the membrane, the seawater and concentrated MOH solution are isolated from one another throughout the process. In preferred embodiments of the invention, the volume ratio within the membrane unit between the MOH solution and the seawater is between about 1:4000 and 1:400. Inside the membrane unit, water passes through the membrane from the relatively dilute seawater solution into the concentrated MOH, diluting the MOH solution to a predetermined level, and thereby concentrating the seawater. The dilute MOH solution exits the membrane unit via valve 205 to dosing point 103, while the seawater exits the membrane unit through valve 202 to exit point 104.

Valves 201-205 may be of any appropriate type chosen from those well-known in the art; in preferred embodiments of the invention, globe valves are used. Likewise, pumps 301 and 302 and check valve 401 may be of any appropriate type or types chosen from those well-known in the art.

According to the method herein disclosed, any aqueous solution that is less concentrated in any solute than the concentrated MOH solution provided from tank 100 can be used in place of seawater. In non-limiting alternative embodiments of the invention, the second aqueous solution is chosen from the group consisting of brackish water, processed water, wastewater, aqueous industrial streams, seawater, at least partially treated salt water, or any combination thereof.

As the H₂O molecules diffuse through the semi-permeable membrane, the pressure (or volume) will increase until osmotic equilibrium is achieved. The theoretical osmotic pressure that is obtained upon dilution of 50% NaOH to 5% is at least 40 bars. This pressure can be regulated to some extent by controlling the flow ratio between the MOH solution and the second aqueous solution to the membrane unit. In some embodiments of the invention, this increase in osmotic pressure is used to inject the diluted MOH into the exhaust gas using an atomizing nozzle. These embodiments have the advantage of saving significant amounts of energy, as it will be necessary to pump only about 1 L of concentrated MOH for every 10 L of diluted MOH injected into the exhaust gas.

In preferred embodiments of the invention, tank 100 and membrane unit 101 are located on a ship. In some of these embodiments, exit point 104 may be optionally located off the ship, and part or all of the concentrated brine is released overboard.

Membranes that selectively transmit water are well-known in the art; the membrane used in the method disclosed here may be of any type appropriate for extended contact with strong base and with the second aqueous solution used in the particular embodiment of the method employed. In addition, the membrane used is of a type appropriate for limiting anion exchange through the membrane. In preferred embodiments of the invention, the membrane is of a type that is additionally characterized as being able to withstand high osmotic pressure. In preferred embodiments of the invention, the membrane is selected from the group consisting of ceramic membranes, polypropylene membranes, polysulfonate membranes, and any combination thereof.

In additional embodiments of the invention, the device for diluting a concentrated MOH solution disclosed above, and the diluted MOH solution thus obtained, are used as part of a flue gas desulfurization (FGD) system. In these embodiments, at least one of the solutions produced by the method (either the diluted MOH solution or the concentrated second aqueous solution) is introduced into a flue gas desulfurization system adapted to permit contact between the solution and the flue gas. Chemical reaction between the SO₂ in the flue gas and the solution leads to at least partial desulfurization of the flue gas. In preferred embodiments of the invention, the entire operation takes place on a ship.

In additional embodiments of the invention, the FGD system further includes a pre-injection zone and a scrubbing unit. In further additional embodiments of the invention, the scrubbing unit includes at least one cyclone unit.

The process of the present invention is especially adapted for use in high capacity engines with capacity of at least 0.5 MW.

The velocity of said flue gas stream inside said scrubbing unit is typically between about 10 m s⁻¹ and 120 m s⁻¹. The volume ratio between the flow of the aqueous stream inside the scrubber and that of the flue gas is between about 0.5 and about 10 L liquid per standard m³ gas, where standard conditions are defined as temperature=20.0° C. (68° F.) and pressure=1.01 bar, (14.72 psia). In preferred embodiments, the volume ratio between the flow of the aqueous stream and that of the flue gas is between about 1 and 4 L per standard m³ gas. In typical embodiments of the invention, the concentration of SO₂ in the flue gas is between about 200 and about 1000 ppm, and the trapping of SO₂ is typically about 75% to about 99%. Injecting diluted NaOH solution to FGD system, especially into the pre-injection zone, significantly increases the trapping of particulate matter.

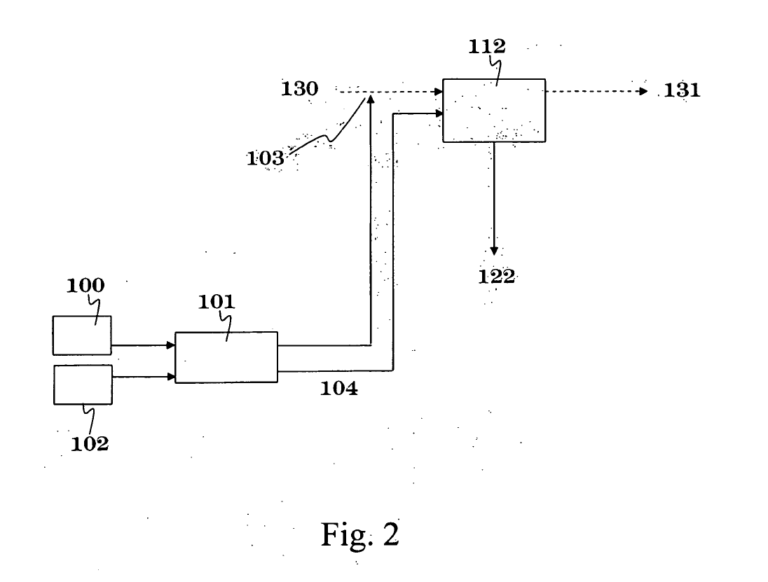

In some embodiments of the invention, the method operates in a “once-through operation.” Reference is now made to FIG. 2, which illustrates schematically once-through operation. Concentrated MOH solution and a second aqueous solution (in preferred embodiments, MOH═NaOH and the second aqueous solution is seawater) pass through membrane unit 101 or a precipitation unit (e.g., a seawater pretreatment unit), producing a diluted MOH solution and a concentrated second aqueous solution as above. A flow of flue gas containing SO₂ (130) encounters the diluted MOH solution at dosage points schematically illustrated in point 103. In embodiments of the invention in which the FGD system contains a pre-injection zone, the diluted MOH may be injected into the pre-injection zone. Concentrated second aqueous solution exits the membrane unit (104) and is then introduced into the scrubber where it contacts the flow of flue gas subsequent to the reaction of the flue gas with the diluted MOH. In embodiments of the invention in which the FGD unit contains a cyclone unit, the concentrated second aqueous solution is injected into the cyclone unit. A flow of at least partially desulfurized flue gas 131 exits the scrubber. A used solution 122, comprising concentrated second aqueous solution and dilute MOH solution after reaction within the scrubber, is discharged, e.g. into the sea. In some embodiments, solution 122 undergoes further treatment prior to discharge. The purpose of the subsequent treatment is to ensure that solution 122 meets the appropriate standards for discharge into the environment.

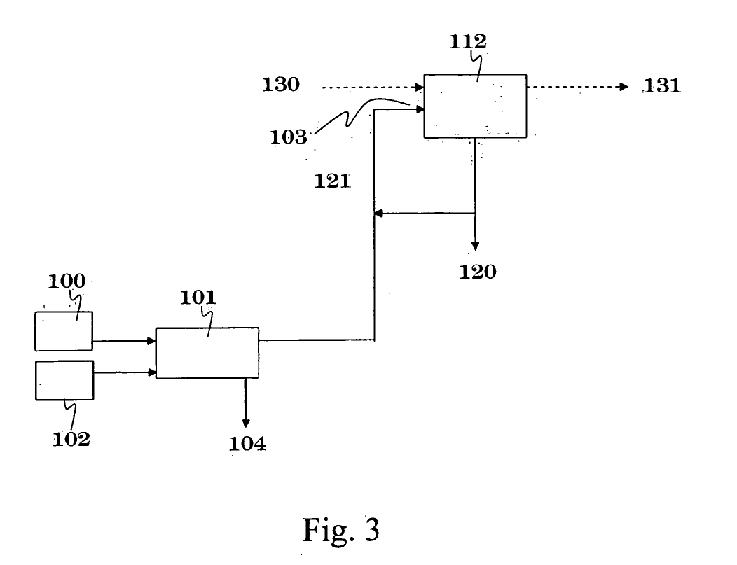

In some embodiments of the invention, the method operates in a “closed-loop operation.” Reference is now made to FIG. 3, which illustrates schematically closed-loop operation. Concentrated MOH solution and a second aqueous solution (in preferred embodiments, MOH═NaOH and the second aqueous solution is seawater) pass through membrane unit 101, producing a diluted MOH solution and concentrated second aqueous solution as above. In the embodiments in which the method operates in closed-loop mode, dosage point 103 is the entrance to scrubber unit 112, and exit point 104 for the concentrated second aqueous solution is discharge from the system, e.g. into the sea, or used onboard for other purposes like cooling. A flow of SO₂-containing flue gas 130 enters the scrubbing unit, where it encounters the dilute MOH solution and is thereby at least partially desulfurized to produce a flow of flue gas 131 with a lower concentration of SO₂ than that of the flue gas in flow 130. In this case, after one pass, the dilute MOH solution still contains sufficient unreacted MOH to still be effective for desulfurizing flue gas. Except for a small amount of “bleed solution” 120 that is discharged in order to remove impurities from the system, the MOH/M₂SOₓ or MHSOx/M₂SOₓ solution exiting the scrubber 121 is returned to the scrubber for further use in the FGD system. Preferably, although it is not presented in FIG. 3, at least part of said diluted MOH solution stream is enters thus, contacted with the SO₂-containing flue gas before the scrubber.

As described above, membrane unit 101 supplies diluted MOH solution to the FGD stage. In a “closed-loop operation” there are two stages for operating membrane unit 101: (a) before the start of the FGD process, and (b) during the FGD process. In stage (a) a large amount of diluted MOH solution is prepared in order to supply the bulk solution that is recycled in the system. In stage (b), when the FGD system in operation, the amount of diluted MOH solution should be about that of the “bleed solution,” which is typically about 10% of the total recycled solution.

The present invention also discloses methods for desulfurization of flue gas in a system in which the FGD system further comprises a seawater pretreatment (SWPT) module adapted for pre-precipitation from water.

In additional embodiments of the invention, the SWPT-FGD process and system comprises steps and means for utilizing an effective measure of flocculants and agglomerators. In preferred embodiments of the present invention, the flocculant is hydrocolloid based. Examples of commercially available flocculants of this type include those marketed by SORBWATER. In a most preferred embodiment of the invention, the flocculant is constructed of materials that enable it to meet or exceed the standards for a “PLONOR” material (poses little or no threat to the marine environment) according to the relevant standards as set by the OSPAR commission.

In another embodiment of the present invention, desulfurization of flue gas by using the PSWT-FGD system as defined above is disclosed, wherein the process includes the additional step of adding a compound selected from the group consisting of CO₂ and NaHCO₃ to at least one of the streams (the mixture, the precipitate rich stream, and the precipitate lean stream) as a means of pre-precipitating Mg and Ca in order to reduce fouling of the system. In additional embodiments of the present invention, CO₂ obtained from flue gas after desulfurization is added to at least one of the streams. In additional embodiments of the invention, a solid compound chosen from the group consisting of CaCO₃, Ca(OH)₂, and any combination thereof is added to at least one of the streams as a source of seed crystals, increasing the mean crystal size so that separation of the precipitate will be easier.

In another embodiment of the present invention the PSWT-FGD system as defined above is disclosed, wherein the process further comprises a stage of filtration or ultra-filtration.

In another embodiment of the present invention, a device for the desulfurization of flue gas using MOH and a second aqueous solution is disclosed. In preferred embodiments of the invention, the second aqueous solution is seawater. The device comprises a storage tank adapted for storage of a concentrated MOH solution 100, a source of a second aqueous solution 102 (in preferred embodiments, this source is simply an inlet allowing seawater to enter the system), a membrane unit 101, and a scrubbing unit 112. The membrane unit comprises a chamber; an interior wall that divides the chamber into at least two sub-chambers, one of which is adapted for flow of MOH solution and connected to the MOH storage tank, and the other of which is adapted for flow of the second aqueous solution and connected to the source of the second aqueous solution; and outlets for the MOH and aqueous solution. At least part of the interior wall is a membrane 501 that selectively transmits water as defined above. At least one of the outlets from the membrane unit is connected to the scrubber. Means are provided for creating a flow of MOH solution from the storage tank to the outlet (in embodiments in which the MOH outlet is connected to the scrubber, from the outlet to the scrubber as well) via the membrane unit. Means are also provided for creating a flow of the second aqueous solution from its source to the outlet (in embodiments in which the outlet for the aqueous solution from the membrane unit is connected to the scrubber, from the outlet to the scrubber as well) via the membrane unit. In alternative embodiments of the invention, the means for creating flow comprise at least one pump, or osmotic pressure as described above, or a combination. The scrubber is adapted to admit flue gas and to allow the flue gas to contact the solution(s) that enter the scrubber from the membrane unit. In some embodiments of the invention, the scrubber further includes a pre-injection unit.

In preferred embodiments of the device, it is located on a ship. This self-contained unit thus allows the use of seawater for dilution of a concentrated solution of MOH for use in FGD.

In preferred embodiments of the invention, it also includes a cyclone unit which is a scrubbing device for the flue gas desulfurization (FGD), comprising a housing defined by a cylindrical peripheral wall thereof and by upper and lower extremities, said housing having a longitudinal axis and being provided with at least one inlet opening for receiving said gaseous stream and at least one inlet opening for receiving said aqueous stream thereinto. Said cyclone unit further comprises an outlet means from said housing preferably formed as a hollow truncated cone, having a large base and a spaced apart small base the large base thereof being in communication with the lower extremity of said housing. A pipe means is placed within said housing, preferably coaxially with the longitudinal axis wherein an uppermost extremity of the pipe means is located outside of the housing, and a lowermost extremity of said pipe means is located within the housing.

Said cyclone unit further comprises at least one swirling means being formed as a cylindrical ring and being mounted within said housing, coaxially with the longitudinal axis so as to provide an annular space between the housing central wall and the peripheral wall of said swirling means and to provide an inner annular space between the central wall of the swirling means and the lowermost extremity of said pipe means.

Said swirling means are defined by a plurality of openings so as to enable passage from said annular space towards said inner annular space. Said passages are characterized by a length of at least 5 cm preferably at least 10 cm.

Using the cyclone unit described above, said gaseous stream enters through at least one of said inlet openings to said annular space and then passes through at least one of said plurality of openings and then at least one passages, preferably more than 10 passages, towards said inner annular space, while said aqueous stream enters through at least one of said inlet openings into said housing and is contacted with said gaseous stream. These two mixed streams are then caused to flow through said hollow truncated cone whereas said gaseous product is exiting though said pipe means, while said wash solution is collected through said small base of said hollow truncated cone whereas said gaseous product is exiting though said pipe means, while said wash solution is collected through said small base of said hollow truncated cone into said appropriate collecting receptacle.

The passage of said gaseous stream through said plurality of openings, and then passages results in an unexpectedly high velocity of said gaseous stream, said velocity being between about 20 m s⁻¹ and about 120 m s⁻¹, and in preferred embodiments between 60 and 70 m s⁻¹. As a result, a very efficient contact between said gaseous and aqueous streams is achieved. This is compared to a typical cyclone scrubber that is characterized by the ability to produce a velocity of about 15-50 m s⁻¹.

It is a further object of the present invention to disclose another preferred cyclone unit which is a scrubbing device for the desulfurization unit of the type described in EP 0971787B1, comprising a housing defined by a cylindrical peripheral wall thereof and by upper and lower extremities, said housing having a longitudinal axis and being provided with at least one inlet opening for receiving streams thereinto, said inlet opening being formed within said peripheral wall and being directed preferably tangentially with respect thereto; an outlet means from said housing being formed preferably as a hollow truncated cone, having a large base and a spaced apart small base, the large base thereof being in communication with the lower extremity of said housing and said small base thereof being in communication with an appropriate collecting receptacle, a pipe means being placed within said housing, preferably coaxially with the longitudinal axis, an uppermost extremity of the pipe means being located outside of the housing and a lowermost extremity of said pipe means being located within the housing; at least one swirling means for imparting vertical motion to said fluid, said swirling means being formed as a tubular member, defined by a peripheral annular wall with an opposite upper and lower end, said swirling means being mounted within said housing coaxially with the longitudinal axis of said housing so as to provide for an annular space therebetween, said swirling means being provided with a plurality of slit-like elongated openings, formed in the peripheral wall thereof so as to enable passage of fluid therethrough, characterized in that said pipe means extends along the swirling means and slit-like openings are arranged regularly on the peripheral wall of the swirling means so as to extend substantially tangentially with respect to the interior thereof, wherein said slit-like openings are defined by a length and width dimension, and wherein the length dimension exceeds the width dimension.

In an additional embodiment of the invention herein disclosed, a method for treating flue gas by using an aqueous solution within an FGD system is provided. This method utilizes an FGD unit with a SWPT module. In a preferred embodiment, the aqueous solution is seawater. The aqueous solution is treated within the SWPT module with a substance that selectively bonds divalent ions over monovalent ions (SSBD). Nonlimiting examples of such substances include flocculants, complexants, and ion exchange materials. By this method, divalent ions such as Ca⁺⁺ and Mg⁺⁺ that can lead to fouling of the system are selectively removed from the solution being used to treat the flue gas by forming an SSBD-ion complex or compound. The bound SSBD-ion complex is then separated from the aqueous solution; in some embodiments, it is added to the used water stream produced by the FGD system. At least part of the remaining aqueous solution (i.e., from which the SSBD-ion complex has been removed) is mixed with an MOH solution, the resulting mixture introduced into the FGD unit, and the flue gas treated as described in detail above. In preferred embodiments, the entire system is located on a ship. In preferred embodiments, the flocculant is a hydrocolloid-based flocculant. In some embodiments, the FGD system includes at least one cyclone unit, preferably of a type disclosed above.

### EXAMPLE

An example is presented of the use of base to pre-precipitate Ca from seawater. In 4 separate experiments seawater containing about 416 ppm Ca was contacted with a 50% NaOH solution at a temperature of 9° C. and pH of 7.75. In some cases Na₂CO₃ was added and/or CO₂ was bubbled into the mixture. The mixture was mixed vigorously for about a minute and allowed to settle for about 16 hours. The Ca concentration in the solution was analyzed periodically. The time needed to achieve about 99% of the maximum precipitation was between 5 and 8 minutes in all cases. Table 1 presents results (Ca concentration after settling, pH after settling, and calculated Ca removal) for the different cases.

TABLE 1

| | ppm | | Ca |
|---|---|---|---|
| Components | Ca | pH | removal |
| 3.45 kg 50% NaOH solution per m³ Seawater | 309 | 10.2 | 26% |
| 7.66 kg 50% NaOH solution per m³ Seawater | 206 | 12.2 | 50% |
| 3.45 kg 50% NaOH solution per m³ Seawater, | 123 | 9.7 | 70% |
| CO₂ bubbled through sample | | | |
| 3.54 kg 50% NaOH solution + 0.3 kg Na₂CO₃ per | <2 | 9.3 | 99% |
| m³ Seawater, CO₂ bubbled through sample | | | |

1. A method for treating flue gas within a flue gas desulfurization (FGD) system, wherein said process comprises:
providing an FGD system, said FGD system comprising a seawater pretreatment (SWPT) module;
mixing seawater with a basic solution within said SWPT module, whereby a precipitate comprising calcium and/or magnesium compounds is formed;
dividing said mixture into at least two streams, at least one of which is a precipitate-rich stream and at least one of which is a precipitate-lean stream; and,
introducing at least part of said precipitate-rich and precipitate-lean streams into said flue gas desulfurization (FGD) system for treating flue gas.

2. The method according to claim 1, wherein said basic solution contains at least one solute selected from the group consisting of (a) sodium hydroxide and (b) sodium bicarbonate.

3. The method according to claim 1, wherein said basic solution comprises a solution of MOH in which the concentration of MOH is between about 10% about 50% (w/v).

4. The method according to claim 3, wherein the concentration of said MOH solution is between about 30% MOH and about 50% MOH (w/v).

5. The method according to claim 1, wherein the volume ratio between said basic solution and said seawater is between about 1:4000 and about 1:50.

6. The method according to claim 1, wherein the volume ratio between said basic solution and said seawater is between about 1:1000 and about 1:50.

7. The method according to claim 1, wherein the volume ratio between said basic solution and said seawater is between about 1:500 and about 1:100.

8. The method according to claim 1, further comprising a step of filtering or ultra-filtering.

9. The method according to claim 1, further comprising a step of adding an effective measure of at least one flocculant and/or agglomerate to at least one stream selected from the group consisting of said mixture, said precipitate-rich stream, and said precipitate-lean stream.

10. The method according to claim 9, wherein said at least one flocculant comprises a hydrocolloid-based flocculant.

11. The method according to claim 9, wherein said at least one flocculant poses little or no risk to the marine environment as defined by the relevant OSPAR standard.

12. The method according to claim 1, further comprising a step of adding at least one compound selected from the group consisting of CO₂ and NaHCO₃ to at least one stream selected from the group consisting of said mixture, said precipitate-rich stream, and said precipitate-lean stream.

13. The method according to claim 12, wherein said step of adding at least one compound selected from the group consisting of CO₂ and NaHCO₃ to at least one stream selected from the group consisting of said mixture, said precipitate-rich stream, and said precipitate-lean stream further comprises a step of adding CO₂ obtained from said flue gas after said treatment to at least one stream selected from the group consisting of said mixture, said precipitate-rich stream, and said precipitate-lean stream.

14. The method according to claim 1, further comprising a step of adding a solid comprising a compound selected from the group consisting of CaCO₃, Ca(OH)₂, and any combination thereof to at least one stream selected from the group consisting of said mixture, said precipitate-rich stream, and said precipitate-lean stream.

15. The method according to claim 1, wherein said FGD system further comprises a pre-injection zone.

16. The method according to claim 15, further comprising a step of introducing at least part of said precipitate-lean stream into said pre-injection zone.

17. The method according to claim 1, further comprising a step of operating said FGD system on a ship.

18.-51. (canceled)
